(19) United States
(12) Patent Application Publication
(10) Pub. No.: US 2019/0022894 A1
(43) Pub. Date: Jan. 24, 2019

(54) DEVICE FOR ON-DEMAND CONCRETE HYDRATION

(71) Applicant: BAKERY CONCEPTS INTERNATIONAL, LLC., Mechanicsburg, PA (US)

(72) Inventor: Kenneth W. Schwenger, Mechanicsburg, PA (US)

(73) Assignee: BAKERY CONCEPTS INTERNATIONAL, LLC., Mechanicsburg, PA (US)

(21) Appl. No.: 16/041,475

(22) Filed: Jul. 20, 2018

Related U.S. Application Data
(60) Provisional application No. 62/535,033, filed on Jul. 20, 2017.

(51) Int. Cl. B28C 5/06; B28C 5/42; B28C 9/00

(52) U.S. Cl. CPC B28C 5/06; B28C 5/422; B28C 5/46; B28C 9/004; B28C 5/4231

(57) ABSTRACT

A mixing apparatus having a processing area that exposes free falling dry materials to a high pressure hydration element and forms slurry with the a mixture of the dray materials and liquid.

### CROSS REFERENCE TO RELATED APPLICATION

This application claims the benefit of U.S. Provisional Application No. 62/535,033, which was filed Jul. 20, 2017 and is incorporated herein by reference in its entirety.

### FIELD OF INVENTION

The present disclosure relates generally to an apparatus for mixing dry materials with a liquid. More particularly, the present disclosure relates to mixing dry materials in an apparatus which directs a high-pressure jet of liquid toward falling dry material to produce slurry. Most particularly, the present disclosure relates to mixing dry materials to produce concrete.

### BACKGROUND

Dry ingredient mixing apparatuses able to produce concrete material are known from the prior art and are often contained within concrete mixing trucks.

Concrete mixing trucks mix and transport concrete for use at work sites. Pre-mixing the concrete in the truck allows for delivery of readily-usable material to sites. However, concrete mixing trucks are not always efficient at this task because concrete hardens quickly, making scheduling of concrete delivery difficult. Once the concrete hardens, it is difficult to remove it from truck mixing barrels. Truck barrels are also ill-suited to controlling and adjusting key process parameters for making concrete with desired properties due to their size and other logistics. Other mixing apparatuses exist but similarly fail to provide adequate on-demand delivery and control over the mixing of concrete.

There exists a need for an improved on-demand concrete mixing apparatus which overcomes the problems associated with current concrete mixing technology.

### SUMMARY

The disclosed apparatus includes an inlet, a hydrating area, and an outlet. The inlet directs dry materials to the hydrating area in order to expose the materials to a controlled high-pressure liquid source. The liquid, generally water, is directed at the dry materials to quickly and evenly hydrate the mixture as it moves to the outlet for use. The apparatus is scalable and can be portable throughout a work site in order to provide on-demand concrete material. The apparatus allows precise control of mixing such that process parameters including volume flow rate and liquid pressure are adjustable to produce concrete material of the desired composition and slump value.

### BRIEF DESCRIPTION OF THE DRAWINGS

FIG. 1 illustrates a hydration apparatus according to a first embodiment.

FIG. 2 illustrates a hydration apparatus according to a second embodiment.

FIG. 3, a section along the line 3-3 in FIG. 1 illustrates an auxiliary apparatus for the adding of a desired liquid to the slurry.

### DETAILED DESCRIPTION

The hydration apparatus is discussed in relation to concrete processing but is usable for mortar like slurries in general. The apparatus is arranged so that dry material, such as concrete, sand, and aggregate are presented in a free-fall to a high-pressure liquid that is directed at the falling materials to achieve the desired hydration. The apparatus components may be independent and assembled on site or arranged in a compact configuration for enhanced portability. The apparatus may be mounted to a structure or remain standalone depending on the feed and production needs.

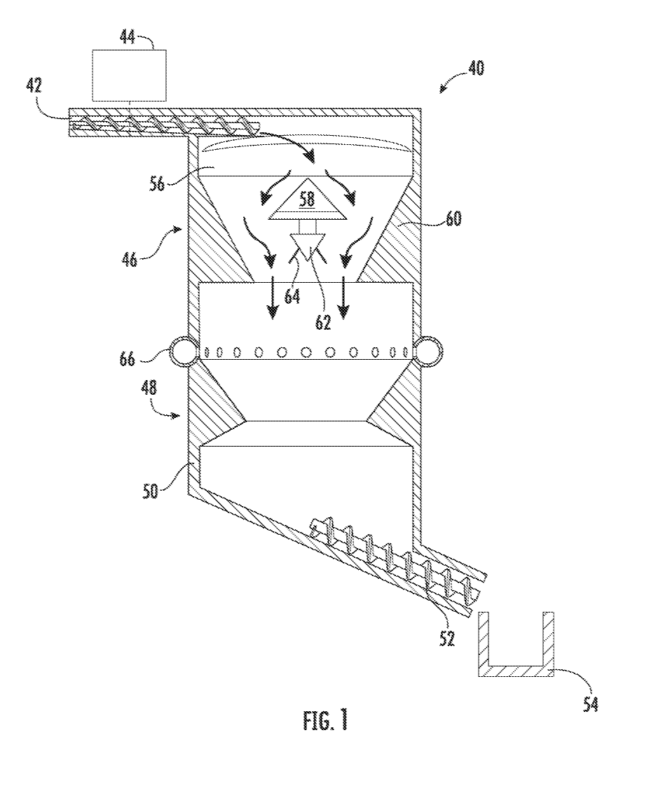

FIG. 1 illustrates a first embodiment of the apparatus 40 that includes a dry material inlet 42, a process controller 44 for controlling the selected materials and quantities presented to the inlet 42. Inlet let 42 is illustrated with a screw conveyor of auger where the material mixed before entering the hydration area 46, which has a funnel shape 56 with an angled cone 60 that presents the materials to the hydration section 58 which includes a nozzle support 62 and liquid spray nozzles 64. A detailed description of a suitable hydration section 58 is shown and described in co-pending application Ser. No. 15/532,503 and is incorporated herein by reference as if fully set forth. Depending on the specific materials and hydration needs, other high pressure hydrators may be provided within the current mixing apparatus. The inlet of the funnel 56 is spaced a sufficient distance from the hydration section 58 so that the materials enter free fall before being present at the hydration section 58.

After the materials are initial hydrated, they fall into a second funnel 48 where they pass by an auxiliary optional hydrator 66 which may be used to add liquid for air entrainment, anti-freeze, retardants and the like.

Following the second funnel 48, the materials released into an inverted funnel 50 where the slurry is ultimately presented to an outlet with a mixing auger 52 which delivers the mixed slurry to a slurry transport container 54.

It can be seen from the above that the disclosed concrete production plant may be sized according to the volume of production needed and the amount of mixing required. Addition non-hydrating mixing devices can be incorporated in funnels 48 and 50. Similarly, the production plant can supply slurry to traditional cement mixing trucks for transport and continued mixing. Using traditional cement trucks for transport will still provide the advantages of having slurry with tightly controlled volumes of dry materials and hydration liquids.

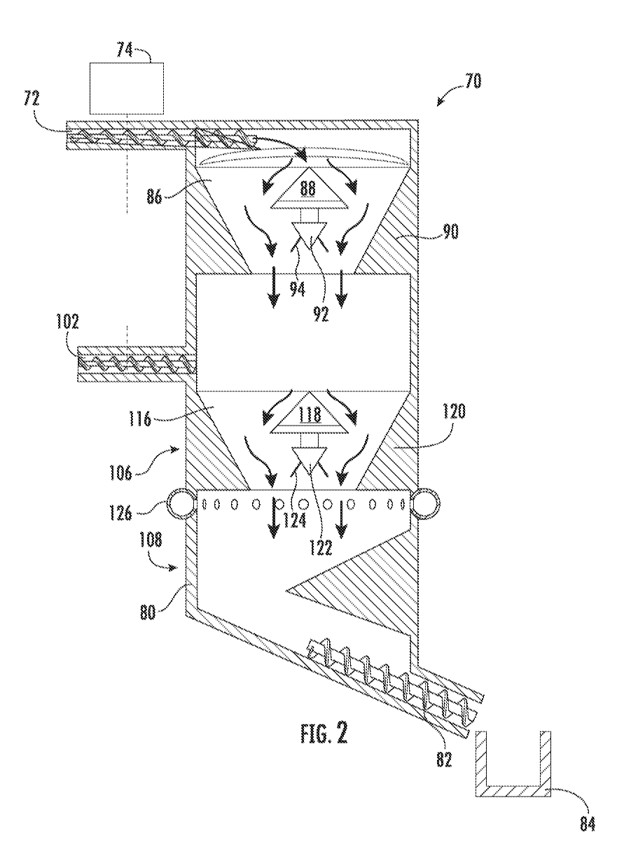

The embodiment 70 of FIG. 2 is similar to that of FIG. 1, and includes a second material inlet and auger 102 and a second hydration section 118. This configuration provides the opportunity to separate materials for delivery and hydration. For example, inlet 72 may present sand and cement to hydrator 88 in cone 86 and the inlet 102 may present aggregate for hydration and mixing with the sand and cement mixture in cone 116. This configuration allows for different high pressure liquid spray. For instance, because sand and cement are finer particles than aggregate, it may be desired to hydrate them separately so that finer particles are not shielded by larger particles.

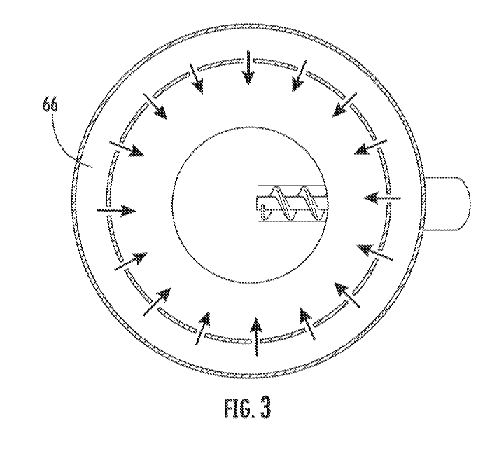

With reference to FIG. 3, there is illustrated a section of the apparatus 40 or 70 that includes a number of openings that can be used to insert a desired number of secondary spray nozzles around the outer surface in an assembly 66. The auxiliary assemble 66 is preferably, but necessarily, a high pressure spray device. The delivery pressure depends on the add mixture being applied.

In the hydration areas, the high-pressure liquid spray is aimed at the dry material in a conical pattern that generates a liquid spray downwardly and outwardly at the ingredients falling over the diverter. This liquid spray causes a slight vacuum which helps to draw materials downward into the high-pressure spray as they are in free fall. The amount of vacuum varies with liquid velocity, liquid volume, spray angle, and the area of the funnel.

Because amount of hydration for concrete is a function of what is generally called the concrete slump test, the pressure of the spray flow is controlled at a selected rate and amount of hydration pressure. The concrete slump test is typically performed with a slump cone that is a right circular cone of about 12 inches in height. The cone tapers from a base of 8 inches in diameter to the top of the cone of 4 inches in diameter. The cone is filled with fresh concrete in three layers of equal volume. Each layer is stroked 25 times with a rod that is ¾ inch in diameter. The end of the rod is bullet shaped. After the cone is filled with concrete leveled off at the top of the cone, the cone is raised vertically and the concrete is allowed to fall or slump. The distance that the concrete falls or slumps from the original height is the slump of the concrete. The variation in slump is generally considered to be an indication of the water in the slurry. It was once thought that concrete was composed of cement, aggregate and water with the coarse aggregates determined the water content and the water determined the slump. Hence, a lower slump value meant lower water content and a higher quality of concrete.

The early thinking was that concrete was 1 part cement and 6 parts sand and aggregate which were generally even in amounts. This was thought to be usable for structures like driveways. A mix of 1 part cement and 8 parts sand and aggregate was thought to be usable for structures like foundation. Today, concrete may include contain admixtures, plasticizer, fibers and polymers. Accordingly, a high or low slump may not be a clear indication of the quality of the concrete and may not be usable to directly determine the water content of a concrete mix. Modern concrete requires ingredient specification and the rate of hydration will depend on the rat of feed for the ingredients and the total liquid volume needed.

The fluid pressure is adjusted according to the desired end product. Different dry ingredients absorb moisture best at different pressures. In any event, the pressurized spray should be at least 20 bar, approximately 290 psi, with the currently preferred range being between 20 and 400 bar, approximately 290 psi and 5801 psi. The currently preferred upper pressure is 300 bar, approximately 4351 psi.

By way of example, a 560 kilo/cubic meter (approximately 34 pounds/cubic foot) density product is made with a maximum of 250 bar (approximately 3,626 psi) and a minimum inlet water flow of 75 liters/minute (approximately 19 gallons/minute). The minimum dry ingredient output for this example is 1,000 kilo/hour (approximately 2204 pounds/hour) and the maximum dry ingredient output is 2,800 kilo/hour (approximately 6172 pounds/hour). The minimum liquid ingredient output is 1,362 liters/hour (approximately 359 gallons/hour) and the maximum liquid ingredient output is 3,400 liters/hour (approximately 898 gallons/hour).

What we claim is:

1. A mortar mixing apparatus, comprising:
a mixing body that contains
an inlet that supplies dry material to a processing area;
a processing area includes a first section where the dry materials are presented to a hydrator that creates a slurry with a high-pressure liquid spray directed at the dry materials and concentrates the slurry at an outlet for presentation to a second section of the processing area;
the second section of the processing area has a slurry receiving inlet that is larger than the outlet of the first section and an outlet that concentrates the slurry and presents it to and delivery area; and
a delivery outlet for finished slurry.

2. The apparatus of claim 1, wherein the dry material are diverted outwardly in the processing area.

3. The apparatus of claim 1, further comprising an auxiliary hydration apparatus.

4. The apparatus of claim 1, further comprising an auger that moves the hydrated slurry.

5. The apparatus of claim 1, wherein the hydrator is pressurized to at least 20 and 400 bar.

6. The apparatus of claim 1, wherein the hydrator is pressurized at a minimum of 200 bar.

7. The apparatus of claim 8, wherein the hydrator is pressurized at a maximum of 300 bar.

8. The apparatus of claim 1, wherein the hydrator is pressurized between 100 and 300 bar.

9. A mortar mixing apparatus, comprising:
a mixing body that contains
a first inlet that supplies dry material to a first processing area;
the first processing area includes a first section where the dry materials are presented to a hydrator that creates a slurry with a high-pressure liquid spray directed at the dry materials and concentrates the slurry at an outlet for presentation to a second section of the processing area;
the second section of the processing area includes a slurry receiving inlet that is larger than the outlet of the first section, a second inlet that supplies dry material at the second processing area, a second hydrator that creates a slurry with a high-pressure liquid spray directed at the second inlet dry materials and the slurry and an outlet that concentrates the slurry and presents it to and delivery area; and
a delivery outlet for finished slurry.

10. The apparatus of claim 9, further comprising an auxiliary hydration apparatus.

11. The apparatus of claim 9, wherein at least one hydrator is pressurized at between at least 20 and 400 bar.

12. The apparatus of claim 9, wherein at least one hydrator is pressurized at a minimum of 200 bar.

13. The apparatus of claim 9, wherein at least one hydrator is pressurized at a maximum of 300 bar.

14. The apparatus of claim 9, wherein at least one hydrator is pressurized between 100 and 300 bar.

15. The apparatus of claim 9, wherein the hydrators are pressurized to at least 20 and 400 bar.

16. The apparatus of claim 9, wherein the hydrators are pressurized at a minimum of 200 bar.

17. The apparatus of claim 9, wherein the hydrators are pressurized at a maximum of 300 bar.

18. The apparatus of claim 9, wherein the hydrators are pressurized between 100 and 300 bar.

19. The apparatus of claim 10, wherein the auxiliary hydration apparatus is pressurized at between at least 20 and 400 bar.
